(19) United States
(12) Patent Application Publication
(10) Pub. No.: US 2024/0320446 A1
(43) Pub. Date: Sep. 26, 2024

(54) METHOD AND SYSTEM FOR MEMORY-BASED GENERATION OF RULES FROM NATURAL LANGUAGE DESCRIPTIONS

(71) Applicant: JPMorgan Chase Bank, N.A., New York, NY (US)

(72) Inventors: Tomas DE LA ROSA TURBIDES, Getafe (ES); Daniel BORRAJO, Pozuelo de Alarcon (ES); Manuela VELOSO, New York, NY (US)

(73) Assignee: JPMorgan Chase Bank, N.A., New York, NY (US)

(21) Appl. No.: 18/124,263

(22) Filed: Mar. 21, 2023

(51) Int. Cl. G06F 40/47; G06F 40/169; G06F 40/186; G06F 40/205

(52) U.S. Cl. CPC G06F 40/47; G06F 40/169; G06F 40/186; G06F 40/205

(57) ABSTRACT

A method for translating natural language data into constraints via memory-based processing is disclosed. The method includes receiving inputs via a graphical user interface, each of the inputs including input wording in a natural language format; parsing, by using a model, the inputs to retrieve a case from a case repository, the retrieval including identification of the case based on a similarity value and a predetermined similarity threshold; automatically adapting, by using the model, the retrieved case to the inputs; generating, based on a result of the adapting, constraints that characterize the inputs, the constraints relating to a rule that is mandated by the input; and evaluating the constraints.

### BACKGROUND

### 1. Field of the Disclosure

This technology generally relates to methods and systems for language processing, and more particularly to methods and systems for providing memory-based techniques to facilitate identification, extraction, and translation of policies expressed in natural language into logic-based rules.

### 2. Background Information

Many business entities rely on rules and constraints found in large volumes of prospectuses to facilitate operations and provide services for users. Often, these prospectuses include general policy guidelines and are only available in a natural language format. Historically, implementations of conventional natural language processing techniques have resulted in varying degrees of success with respect to identifying, extracting, and translating the policy guidelines into the required rules and constraints.

One drawback of using the conventional natural language processing techniques is that in many instances, the prospectuses are dynamic documents that are regularly updated and changed. As a result, the conventional natural language processing techniques require continuous repetition of processing cycles. Additionally, due to the continuous repetition, maintenance of existing rules and constraints may be problematic.

Therefore, there is a need for a memory-based (usually called Case-Based Reasoning) natural language processing approach that automatically adapts known cases to new input parameters to effectively and efficiently facilitate identification, extraction, and translation of policies into rules and constraints.

### SUMMARY

The present disclosure, through one or more of its various aspects, embodiments, and/or specific features or sub-components, provides, inter alia, various systems, servers, devices, methods, media, programs, and platforms for providing memory-based natural language processing to facilitate identification, extraction, and translation of policies into rules.

According to an aspect of the present disclosure, a method for translating natural language data into constraints via memory-based processing is disclosed. The method is implemented by at least one processor. The method may include receiving, via a graphical user interface, at least one input, each of the at least one input may include input wording in a natural language format; parsing, by using at least one model, the at least one input to retrieve at least one case from a case repository, the retrieval may include identification of the at least one case based on a predetermined similarity threshold; automatically adapting, by using the at least one model, the retrieved at least one case to the at least one input; generating, based on a result of the adapting, at least one constraint that characterizes the at least one input, the at least one constraint may relate to a rule that is mandated by the at least one input; and evaluating the at least one constraint.

In accordance with an exemplary embodiment, the input wording may include at least one from among a word, a phrase, a sentence, a paragraph, and a document in the natural language format, the document may include electronic data in a document file format.

In accordance with an exemplary embodiment, to parse the at least one input to retrieve the at least one case, the method may further include determining, by using the at least one model, at least one annotation for the at least one input, the at least one annotation may include a set of text abstractions and a corresponding word mapping; determining, by using the at least one model, a similarity value between the at least one input and each of a plurality of cases in the case repository, the similarity value may relate to a distance between a plurality of data points in a similarity grouping; and identifying the at least one case based on the similarity value and the predetermined similarity threshold.

In accordance with an exemplary embodiment, to determine the at least one annotation, the method may further include accessing at least one predefined list of concepts, the concepts may include a set of values that are expected to appear in the at least one input and a text pattern matching expression that represents the set of values; and determining, by using the at least one model, the at least one annotation for the at least one input based on the at least one predefined list of concepts.

In accordance with an exemplary embodiment, to automatically adapt the retrieved at least one case to the at least one input, the method may further include computing, by using the at least one model, a merged mapping by updating an input word mapping of the at least one input with a case word mapping of the retrieved at least one case; and generating a constraint template based on the retrieved at least one case.

In accordance with an exemplary embodiment, to generate the at least one constraint, the method may further include replacing a set of text abstractions in the retrieved at least one case with information from the parsed at least one input by using the merged mapping; and generating the at least one constraint by using the constraint template and a result of the replacing.

In accordance with an exemplary embodiment, to evaluate the at least one constraint, the method may further include presenting, via the graphical user interface, a notification to at least one user associated with the at least one input, the notification may include at least one from among the at least one constraint, a request for user feedback, and information that relates to retrieval of the at least one case; and determining whether the generated at least one constraint includes information that corresponds to the at least one input based on the user feedback, wherein the user feedback may be positive when the generated at least one constraint includes information that corresponds to the at least one input; and wherein the user feedback may be negative when the generated at least one constraint does not include information that corresponds to the at least one input.

In accordance with an exemplary embodiment, the method may further include requesting, via the graphical user interface, at least one correct constraint from the at least one user when the user feedback is negative; aggregating data that corresponds to the at least one input, the data may include the input wording and at least one related annotation; computing a new annotation for each of the at least one correct constraint; generating a new case by appending the new annotation to the aggregated data; and indexing the new case for storage in the case repository.

In accordance with an exemplary embodiment, the at least one model may include at least one from among a natural language processing model, a machine learning model, a mathematical model, a process model, and a data model.

According to an aspect of the present disclosure, a computing device configured to implement an execution of a method for translating natural language data into constraints via memory-based processing is disclosed. The computing device including a processor; a memory; and a communication interface coupled to each of the processor and the memory, wherein the processor may be configured to receive, via a graphical user interface, at least one input, each of the at least one input may include input wording in a natural language format; parse, by using at least one model, the at least one input to retrieve at least one case from a case repository, the retrieval may include identification of the at least one case based on a predetermined similarity threshold; automatically adapt, by using the at least one model, the retrieved at least one case to the at least one input; generate, based on a result of the adapting, at least one constraint that characterizes the at least one input, the at least one constraint may relate to a rule that is mandated by the at least one input; and evaluate the at least one constraint.

In accordance with an exemplary embodiment, the input wording may include at least one from among a word, a phrase, a sentence, a paragraph, and a document in the natural language format, the document may include electronic data in a document file format.

In accordance with an exemplary embodiment, to parse the at least one input to retrieve the at least one case, the processor may be further configured to determine, by using the at least one model, at least one annotation for the at least one input, the at least one annotation may include a set of text abstractions and a corresponding word mapping; determine, by using the at least one model, a similarity value between the at least one input and each of a plurality of cases in the case repository, the similarity value may relate to a distance between a plurality of data points in a similarity grouping; and identify the at least one case based on the similarity value and the predetermined similarity threshold.

In accordance with an exemplary embodiment, to determine the at least one annotation, the processor may be further configured to access at least one predefined list of concepts, the concepts may include a set of values that are expected to appear in the at least one input and a text pattern matching expression that represents the set of values; and determine, by using the at least one model, the at least one annotation for the at least one input based on the at least one predefined list of concepts.

In accordance with an exemplary embodiment, to automatically adapt the retrieved at least one case to the at least one input, the processor may be further configured to compute, by using the at least one model, a merged mapping by causing the processor to update an input word mapping of the at least one input with a case word mapping of the retrieved at least one case; and generate a constraint template based on the retrieved at least one case.

In accordance with an exemplary embodiment, to generate the at least one constraint, the processor may be further configured to replace a set of text abstractions in the retrieved at least one case with information from the parsed at least one input by using the merged mapping; and generate the at least one constraint by using the constraint template and a result of the replacing.

In accordance with an exemplary embodiment, to evaluate the at least one constraint, the processor may be further configured to present, via the graphical user interface, a notification to at least one user associated with the at least one input, the notification may include at least one from among the at least one constraint, a request for user feedback, and information that relates to retrieval of the at least one case; and determine whether the generated at least one constraint includes information that corresponds to the at least one input based on the user feedback, wherein the user feedback may be positive when the generated at least one constraint includes information that corresponds to the at least one input; and wherein the user feedback may be negative when the generated at least one constraint does not include information that corresponds to the at least one input.

In accordance with an exemplary embodiment, the processor may be further configured to request, via the graphical user interface, at least one correct constraint from the at least one user when the user feedback is negative; aggregate data that corresponds to the at least one input, the data may include the input wording and at least one related annotation; compute a new annotation for each of the at least one correct constraint; generate a new case by appending the new annotation to the aggregated data; and index the new case for storage in the case repository.

In accordance with an exemplary embodiment, the at least one model may include at least one from among a natural language processing model, a machine learning model, a mathematical model, a process model, and a data model.

According to an aspect of the present disclosure, a non-transitory computer readable storage medium storing instructions for translating natural language data into constraints via memory-based processing is disclosed. The storage medium including executable code which, when executed by a processor, may cause the processor to receive, via a graphical user interface, at least one input, each of the at least one input may include input wording in a natural language format; parse, by using at least one model, the at least one input to retrieve at least one case from a case repository, the retrieval may include identification of the at least one case based on a predetermined similarity threshold; automatically adapt, by using the at least one model, the retrieved at least one case to the at least one input; generate, based on a result of the adapting, at least one constraint that characterizes the at least one input, the at least one constraint may relate to a rule that is mandated by the at least one input; and evaluate the at least one constraint.

In accordance with an exemplary embodiment, the input wording may include at least one from among a word, a phrase, a sentence, a paragraph, and a document in the natural language format, the document may include electronic data in a document file format.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing memory-based natural language processing to facilitate identification, extraction, and translation of policies into rules.

FIG. 4 is a flowchart of an exemplary process for implementing a method for providing memory-based natural language processing to facilitate identification, extraction, and translation of policies into rules.

FIG. 5 is a diagram of an exemplary process for implementing a method for providing memory-based natural language processing to facilitate identification, extraction, and translation of policies into rules.

FIG. 6 is a table of an exemplary case representation for implementing a method for providing memory-based natural language processing to facilitate identification, extraction, and translation of policies into rules.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

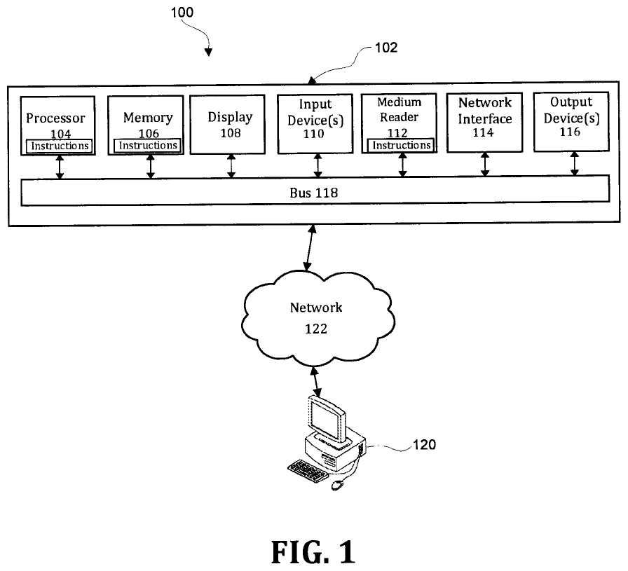

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing memory-based natural language processing to facilitate identification, extraction, and translation of policies into rules.

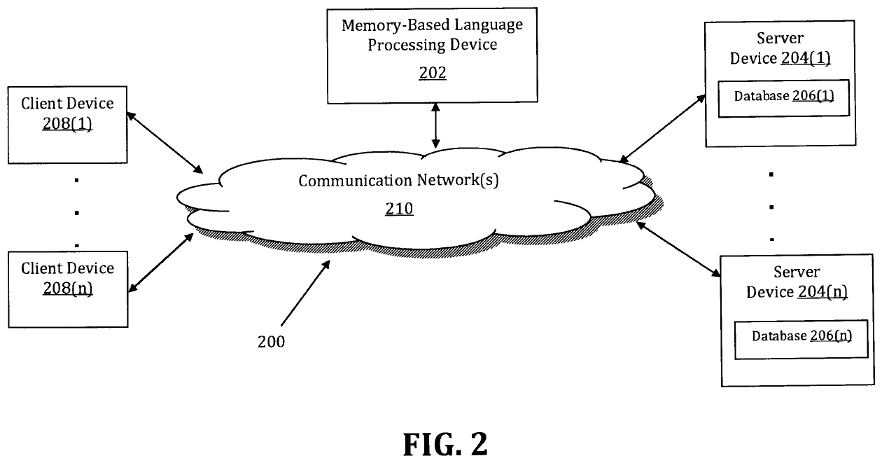

Referring to FIG. 2, a schematic of an exemplary network environment 200 for implementing a method for providing memory-based natural language processing to facilitate identification, extraction, and translation of policies into rules is illustrated. In an exemplary embodiment, the method is executable on any networked computer platform, such as, for example, a personal computer (PC).

The method for providing memory-based natural language processing to facilitate identification, extraction, and translation of policies into rules may be implemented by a Memory-Based Language Processing (MBLP) device 202. The MBLP device 202 may be the same or similar to the computer system 102 as described with respect to FIG. 1. The MBLP device 202 may store one or more applications that can include executable instructions that, when executed by the MBLP device 202, cause the MBLP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MBLP device 202 itself, may be located in virtual server(s) running in a cloud-based computing environment rather than being tied to one or more specific physical network computing devices. Also, the application(s) may be running in one or more virtual machines (VMs) executing on the MBLP device 202. Additionally, in one or more embodiments of this technology, virtual machine(s) running on the MBLP device 202 may be managed or supervised by a hypervisor.

In the network environment 200 of FIG. 2, the MBLP device 202 is coupled to a plurality of server devices 204(1)-204(n) that hosts a plurality of databases 206(1)-206(n), and also to a plurality of client devices 208(1)-208(n) via communication network(s) 210. A communication interface of the MBLP device 202, such as the network interface 114 of the computer system 102 of FIG. 1, operatively couples and communicates between the MBLP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MBLP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MBLP devices that efficiently implement a method for providing memory-based natural language processing to facilitate identification, extraction, and translation of policies into rules.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MBLP device 202 may be a standalone device or integrated with one or more other devices or apparatuses, such as one or more of the server devices 204(1)-204(n), for example. In one particular example, the MBLP device 202 may include or be hosted by one of the server devices 204(1)-204(n), and other arrangements are also possible. Moreover, one or more of the devices of the MBLP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MBLP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to natural language data, constraints, rules, input wordings, cases, similarity thresholds, annotations, queries, text abstractions, word mappings, and similarity values.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MBLP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MBLP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MBLP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MBLP device 202, the server devices 204(1)-204(n), or the client devices 208(1)-208(n), for example, may be configured to operate as virtual instances on the same physical machine. In other words, one or more of the MBLP device 202, the server devices 204(1)-204(n), or the client devices 208(1)-208(n) may operate on the same physical device rather than as separate devices communicating through communication network(s) 210. Additionally, there may be more or fewer MBLP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

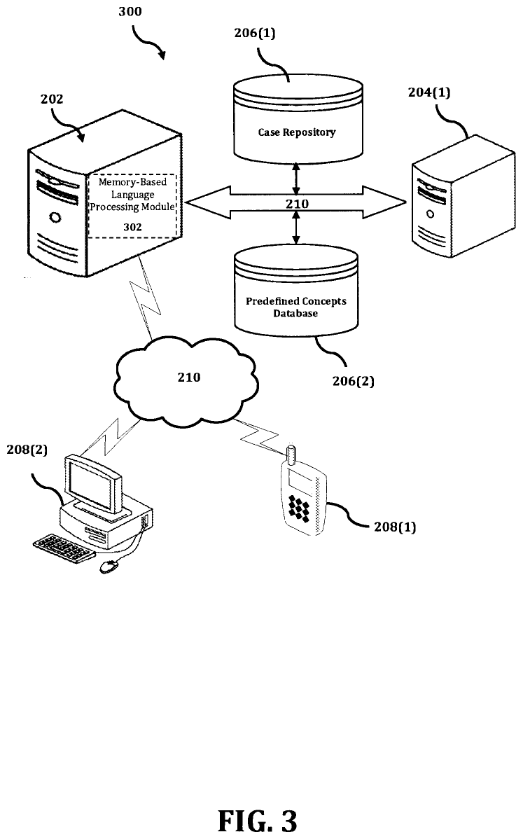

The MBLP device 202 is described and shown in FIG. 3 as including a memory-based language processing module 302, although it may include other rules, policies, modules, databases, or applications, for example. As will be described below, the memory-based language processing module 302 is configured to implement a method for providing memory-based natural language processing to facilitate identification, extraction, and translation of policies into rules.

An exemplary process 300 for implementing a mechanism for providing memory-based natural language processing to facilitate identification, extraction, and translation of policies into rules by utilizing the network environment of FIG. 2 is shown as being executed in FIG. 3. Specifically, a first client device 208(1) and a second client device 208(2) are illustrated as being in communication with MBLP device 202. In this regard, the first client device 208(1) and the second client device 208(2) may be “clients” of the MBLP device 202 and are described herein as such. Nevertheless, it is to be known and understood that the first client device 208(1) and/or the second client device 208(2) need not necessarily be “clients” of the MBLP device 202, or any entity described in association therewith herein. Any additional or alternative relationship may exist between either or both of the first client device 208(1) and the second client device 208(2) and the MBLP device 202, or no relationship may exist.

Further, MBLP device 202 is illustrated as being able to access a case repository 206(1) and a predefined concepts database 206(2). The memory-based language processing module 302 may be configured to access these databases for implementing a method for providing memory-based natural language processing to facilitate identification, extraction, and translation of policies into rules.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MBLP device 202 via broadband or cellular communication. Of course, these embodiments are merely exemplary and are not limiting or exhaustive.

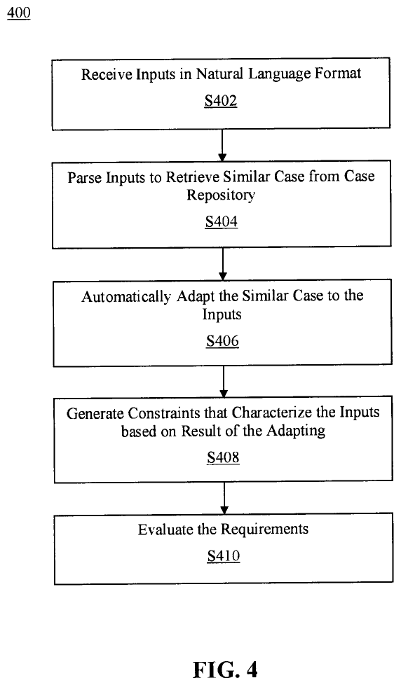

Upon being started, the memory-based language processing module 302 executes a process for providing memory-based natural language processing to facilitate identification, extraction, and translation of policies into rules. An exemplary process for providing memory-based natural language processing to facilitate identification, extraction, and translation of policies into rules is generally indicated at flowchart 400 in FIG. 4.

In the process 400 of FIG. 4, at step S402, inputs may be received via a graphical user interface. Each of the inputs may include input wording in a natural language format. In an exemplary embodiment, the input wording may include at least one from among a word, a phrase, a sentence, a paragraph, and a document in the natural language format. The document may include electronic data in a document file format such as, for example, a portable document format (PDF).

In another exemplary embodiment, the document may correspond to a document in a physical format such as, for example, a printed document that must be converted to the document file format prior to ingestion by the claimed invention. The document may be converted from the physical format to the document file format by using a computing peripheral such as, for example, a computer scanner that optically scans images, printed text, handwriting, and/or objects for conversion to a digital image. In another exemplary embodiment, additional preprocessing steps may be required to prepare the document for ingestion by the claimed invention. The additional preprocessing steps may include an extraction step that extracts plain texts from the document as well as a filtration step that filters content in the document to identify policy related texts.

In another exemplary embodiment, the input wording may correspond to a disclosure document such as, for example a prospectus that describes a policy in a natural language such as, for example, an English language to indicate constraints over a governed subject matter. For example, a fund prospectus may describe investment policies in a natural language to indicate constraints over an associated holding. The holding constraints may include types of securities, allowed percentages, jurisdictions, credit ratings, among other features. In another exemplary embodiment, consistent with present disclosure, the input wording may result from preprocessing steps that are applied to the disclosure document. The input wording may include a set of statements that contains a policy constraint.

In another exemplary embodiment, the natural language format may relate to a defined structure for the processing, storage, and/or display of language data. The language data may include linguistic components such as, for example, alphabetic, numeric, and symbolic characters that are usable to facilitate communication amongst and between users and computing components. Together, the linguistic components may form a structured system of communication that consists of grammar and vocabulary. The structured system may include a human language such as, for example, the English language as well as computing languages for writing computer programs and algorithms such as, for example, machine language, assembly language, and high-level language.

In another exemplary embodiment, the graphical user interface may correspond to a user interface that allows users to interact with electronic devices. The users may interact with the electronic devices though graphical icons and audio indicators. In another exemplary embodiment, the graphical user interface may include graphical elements such as, for example, windows, icons, and menus that facilitate the carrying out of commands such as, for example, opening, deleting, and moving files. The users may interact with the graphical elements via input devices such as, for example, a mouse and keyboard.

At step S404, the inputs may be parsed to retrieve similar cases from a case repository. The inputs may be parsed by using a model and the retrieval process may include identification of the similar cases based on a predetermined similarity threshold. In an exemplary embodiment, parsing the inputs to retrieve similar cases may include determining annotations for each of the inputs. The annotations may include a set of text abstractions and corresponding word mappings. Consistent with present disclosures, the model may be usable to facilitate the determining process. For example, a natural language model may be usable to identify, filter, and extract linguistic elements to facilitate the text abstractions and word mappings.

Then, to facilitate the retrieval process, a similarity function such as, for example, a Jaccard Index between the inputs and each of a plurality of cases in the case repository may be determined. The similarity function may relate to a distance between a plurality of data points such as, for example, meaningful words in a similarity grouping. The distance may represent a quantifiable similarity between each of the plurality of data points. For example, a short distance may indicate a similarity between two data points and a long distance may indicate a dissimilarity. Consistent with present disclosures, the model may be usable to facilitate the determining process.

Finally, the similar cases may be identified based on the similarity value and the predetermined similarity threshold. The predetermined similarity threshold may be usable to device whether a nearest case is retrieved. The predetermined similarity threshold may be defined to indicate a distance above which the nearest case is deemed not similar. The predetermined similarity threshold may be adjusted as required via interaction with the graphical user interface.

In another exemplary embodiment, the similar cases may relate to a representation of system knowledge in a case-based reasoning approach to artificial intelligence. The case-based reasoning approach may correspond to an artificial intelligence technique that provides solutions to problems by using analogy to various representations of system knowledge. The main hypothesis may be that similar problems might have similar solutions, so it is easier to remember the most similar case from the experience and then adapt the previous solution to fit the current problem details.

In another exemplary embodiment, the case repository may correspond to a collection of cases that represent the system knowledge in the case-based reasoning approach. The way in which cases are physically stored may depend on the implementation of software components. Using local comma-separated value (CSV) files or standard database systems are valid alternatives provided there is an interface for basic operations such as, for example, insertion, deletion, and update operations. In another exemplary embodiment, the cases stored in the case repository may be indexed according to a shared characteristic such as, for example, cases from a certain source. For example, the cases in the case repository may be indexed based on a given source to group together similar writing styles.

In another exemplary embodiment, to determine the annotation for the inputs, a predefined list of concepts may be accessed. The concepts may include a set of values that are expected to appear in the inputs and a text pattern matching expression such as, for example, a regular expression (REGEXPS) that represents the set of values. Determining the annotation for a given input may relate to a process for computing an abstraction of the text in the input together with a corresponding text mapping that enables a reconstruction of the original text.

In the annotation process, a numeric suffix may be appended to the abstract concept to account for several occurrences of the same concept so that the mapping has a unique value to facilitate substitutions. Then, the annotation may be determined for the inputs based on the predefined list of concepts. Consistent with present disclosures, the model may be usable to facilitate the determining process.

For example, for textual input “Aggregate investment in equity and fixed income will not exceed 85% of net asset value,” the abstraction may include “Aggregate investment in ASSETCLASS_0 and ASSETCLASS_1 will not exceed PERCENTAGE_0 of net asset value.” A corresponding mapping may be determined to be “{ASSETCLASS_0: equity, ASSETCLASS_1: fixed income, PERCENTAGE_0: 85%}.”

In another exemplary embodiment, the model may include at least one from among a natural language processing model, a machine learning model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

At step S406, the retrieved similar cases may be automatically adapted to the inputs by using the model. In an exemplary embodiment, the automatic adaptation process may be executed when there is a similar case retrieved at the retrieval phase. Otherwise, an empty solution is returned in response to the inputs.

In another exemplary embodiment, to automatically adapt the retrieved cases to the inputs, a merged mapping may be computed. Consistent with present disclosures, the model may be usable to enable the computing process. To facilitate the computation, an input word mapping for each of the inputs may be updated with a case word mapping of the retrieved similar cases. Then, a constraint that is adapted to the inputs may be generated based on the retrieved cases and the previously updated mapping. For example, the word mapping of the inputs may be updated with the word mapping of the retrieved similar cases. The rationale here is that the retrieved rule template should have a complete substitution in order to replace all abstract concepts in the template.

At step S408, constraints that characterize the inputs may be generated based on a result of the adapting. The constraints may relate to a rule that is mandated by the inputs. In an exemplary embodiment, to generate the constraints, a set of text abstractions in the retrieved similar cases may be replaced with information from the parsed inputs. The text abstractions may be replaced by using the merged mapping. Then, the constraints may be generated by using the constraint template and a result of the replacing. For example, a new rule proposal may be built to replace abstract concepts in the rule template with the merged mapping computed before.

At step S410, the constraints may be evaluated. In an exemplary embodiment, to facilitate the evaluation of the constraints, a notification may be presented to users associated with the inputs. The notification may be presented to the users via the graphical user interface. The notification may include at least one from among the constraints, a request for user feedback, and information that relates to retrieval of the similar cases. Then, a determination may be made as to whether the generated constraints include information that corresponds to the inputs. The determination may be made based on the user feedback. For example, the generated constraints may include information that corresponds to the inputs when the user feedback is positive. Alternatively, the generated constraints may not include information that corresponds to the inputs when the user feedback is negative.

In another exemplary embodiment, correct constraints may be requested from the users when the user feedback is negative. The correct constraints may be requested from the users via the graphical user interface. Data that corresponds to the inputs may be aggregated. The data may include the input wording and related annotations. Then, a new annotation for each of the correct constraints may be computed. A new case may be generated by appending the new annotation to the aggregated data. Finally, the new case may be indexed for storage in the case repository consistent with present disclosures. As will be appreciated by a person of skill in the art, incremental learning may be supported by iteratively processing the user feedback consistent with present disclosures.

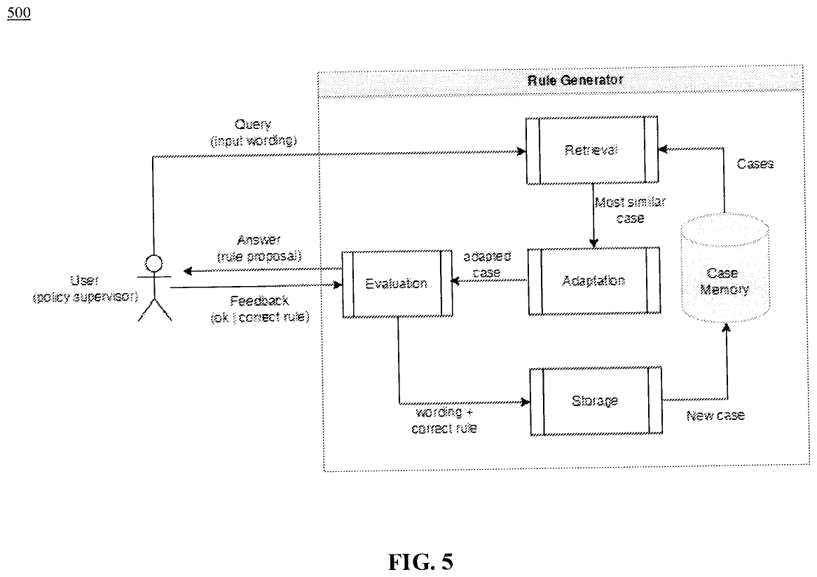

FIG. 5 is a diagram 500 of an exemplary process for implementing a method for providing memory-based natural language processing to facilitate identification, extraction, and translation of policies into rules. In FIG. 5, a case-based reasoning (CBR) approach to artificial intelligence is presented. The case-based reasoning approach may correspond to an artificial intelligence technique that provides solutions to problems by using analogy to various representations of system knowledge. The main hypothesis may be that similar problems might have similar solutions, so it is easier to remember the most similar case from the experience and then adapt the previous solution to fit the current problem details. The learning process may be incremental because the approach implies a continuous cycle of a retrieval phase, an adaptation phase, an evaluation phase, and a storage phase.

As illustrated in FIG. 5, the retrieval phase may include looking in the memory for the most similar wording to the query. When the similar wording exists, retrieve the matching case containing the wording and its corresponding rule. In the adaptation phase, when the wording of the retrieved case is not equal to the input wording, the rule might need some changes to fit to the new wording. When there is not a similar case, the retrieval and adaptation fail and return an empty solution. In the evaluation phase, a new solution is proposed to the user who confirms whether the solution is correct. When the new solution is not correct, including when the solution is empty, the user will supply the correct solution. In the storage phase, when the user provides the correct rule for the query, the system computes the annotations and then composes a new case to store it in the memory of cases.

Consistent with present disclosures, a user may initiate the rule generation process by inputting a query. The query may relate to input wording provided by the user as part of a request for generation of a corresponding output rule. The input wording may be preprocessed prior to inputting to extract plain text from a document so that policy related text may be filtered from other content in the document.

Thus, the input may be stated in terms of a wording such as, for example, a set of statements that contain a policy constraint. The output may include a rule with the form of a concise standardized phrase encoding the constraint such as, for example, “Max 30% in fixed income” or “No investments in other UCIs”. Alternatively, the rule may be expressed in a more formal language, such as, for example, “IF fixed-income>30% THEN check” or “IF UCIs>0 THEN check”. Consistent with present disclosures, a case may be represented for reasoning as a tuple of wording, rule, and annotations where annotations correspond to a set of text abstractions and the required substitutions to make the abstract text equivalent to the original one. These annotations may be computed for both wording and rule.

### Abstraction and Annotation

Sentences used to describe various policies may not have a fixed format. However much of the terminology may be common and sometimes interchangeable, especially when the type of constraint is the same and the writing style comes from the same source. In the context of a textual CBR system, information must be represented efficiently so the system can scale and be able to generalize on texts with interchangeable elements.

Thus, text abstraction may be considered as a key feature of the system knowledge, i.e., case, representation. For example, the sentence “Aggregate limit of Equity may not exceed 75% net exposure,” may be represented as “Aggregate limit of ASSETCLASS may not exceed PERCENTAGE net exposure” given that assetclass and percentage are general concepts that apply for many other instances of the same categories. Formally, a mapping is a set of (concept, value) pairs, written as “{concept1: value1, . . . , concept(n): value(n)}”, such that when each concept(i) is replaced by its associated value(i) in an abstract text, the result is the original text.

Therefore, the above abstract text may capture other constraints expressed in the same way even though the actual values are different. For instance, “Aggregate limit of Non-Investment Grade Fixed Income may not exceed 45% net exposure” is an equivalent sentence given that it has the same abstraction as above, but with a different mapping, i.e., “{assetclass: Non-investment grade fixed income, percentage: 45%}”.

To extract these abstractions automatically, a system may need a predefined list of concepts to use for abstraction such as, for example, asset class, percentage, issuer, rating, etc. The list may be extended with other concepts. Each concept may include a set of valid values that are expected to appear in wordings from a prospectus universe. Additionally, each concept may include a regular expression that can match all relevant examples of that concept.

The annotation may correspond to a process of computing the abstract text of a given text together with the mapping that allow us to reconstruct the original text. In the annotation, a numeric suffix may be appended to the abstract concept to account for several occurrences of the same concept, and therefore the mapping still has a unique value for substitution. This is achieved by finding the occurrences of different concepts by using the corresponding regular expression, and then building the substitution map from all matches. For instance, the original and the abstract version with numbered categories/concepts may be presented as “The fund will limit the exposure to MBS or ABS to 10% of the total assets” and “The fund will limit the exposure to ASSETS_0 or ASSETS_1 to PERCENTAGE_0 of the total assets”.

### Retrieval Phase

The retrieval process may be executed when a new query is received. To retrieve the most similar case, the following three steps may be executed. Step 1 may include computing annotations for the input wording consistent with present disclosures. Step 2 may include computing the similarity of the abstract input wording to all wordings of the cases in the memory. This is done at a certain level to only compare cases with similar writing style. The similarity between cases relies on the computation of a distance measure where the lower the distance, the more similar the case. The Jaccard distance may be used over the set of meaningful words, i.e., words that do not include stop words, in the abstract wording. Specifically,

$$distance Jaccard = 1 - ratio iou .$$

The “ratioiou” may compute the ratio between the size of word intersections and the size of word unions in the abstract wordings.

Step 3 may include generating the solution from the case with the lowest distance, i.e., the nearest case. A similarity threshold may be defined to indicate the distance above which the nearest case is deemed not similar. For example, the similarity threshold may be empirically set to 0.35. When there is a similar case, it will we passed to the adaptation phase. Otherwise, an empty solution is returned to indicate the system cannot handle the query.

### Adaptation Phase

The adaptation process may be executed when there is a similar case retrieved at the retrieval phase. Otherwise, the adaptation phase returns the empty solution. The process may consist of two steps. In the first step, a merged mapping may be computed. The wording mapping of the query is updated with the wording mapping of the retrieved case. The rationale here is that the retrieved rule template should have a complete substitution in order to replace all abstract concepts in the template. In the second step, rule template substitution may be initiated. The new rule proposal is built replacing abstract concepts in the rule template with the merged mapping that was previously computed.

### Evaluation Phase

This phase may consist of a human-computer interaction in which the system presents the rule proposal or notifies the user that the system cannot handle the given input. When there is a proposal, the user needs to evaluate whether the rule has the right representation for the input wording. When the user accepts the proposal, the system receives positive feedback and no other action is taken regarding the query. When the user indicates the proposal is wrong or when there is no proposal, the system prompts the user to provide the correct rule, which will be handled in the storing phase.

### Storing Phase

The storing process may keep in the memory the cases that do not have a similar case or when a rule proposal has been rejected by the user in the evaluation phase. In both situations it is assumed that the user feedback is received with the correct version of the rule. There may be three specific steps for storing a new case.

In step 1, the input wording and its annotations may be collected from the previous phases. In step 2, the new rule annotations may be computed for appending to the collected wording and annotations to create a complete case. Then, in step 3, the new case is stored in memory and indexed based on a characteristic. The idea is to group together cases with similar characteristics such as, for example, writing style. The way in which cases are physically stored depends on the implementation of the software components. Using local CSV files or a standard database system are valid alternatives provided there is an interface for basic operations of insertion, deletion, and updates.

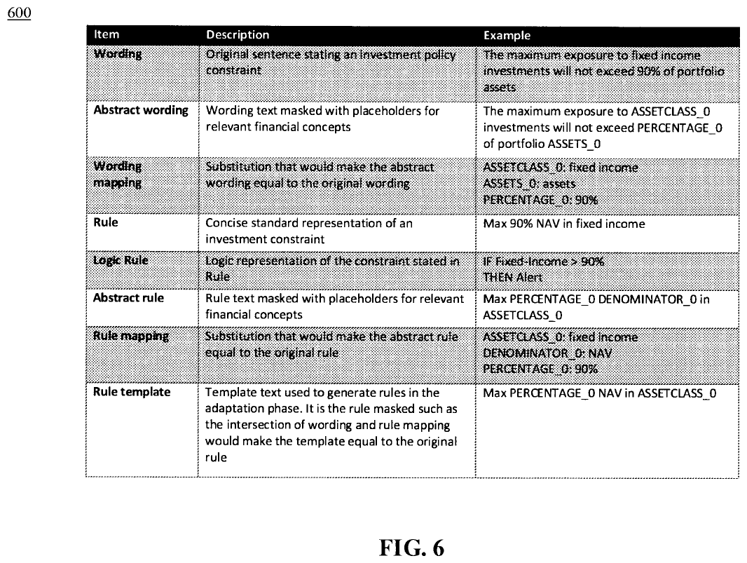

FIG. 6 is a table 600 of an exemplary case representation for implementing a method for providing memory-based natural language processing to facilitate identification, extraction, and translation of policies into rules. In FIG. 6, a case may contain the elements in table 600.

A case may relate to a basic unit of knowledge generated from a prospectus wording and its corresponding rule. The text annotation may be computed for both the wording and the rule. The rule template may relate to a way to link wording and rule within a case. Note that matching for retrieval is done among wordings, but rules need to be generated. Therefore, a wording mapping would be useful only when it shares some values with the rule mapping. Since the sentences in the wording could express several constraints, the case representation should be able to handle multiple rules per case.

Accordingly, with this technology, an optimized process for providing memory-based natural language processing to facilitate identification, extraction, and translation of policies into rules is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory.

Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for translating natural language data into constraints via memory-based processing, the method being implemented by at least one processor, the method comprising:
receiving, by the at least one processor via a graphical user interface, at least one input, each of the at least one input including input wording in a natural language format;
parsing, by the at least one processor using at least one model, the at least one input to retrieve at least one case from a case repository, the retrieval including identification of the at least one case based on a predetermined similarity threshold;
automatically adapting, by the at least one processor using the at least one model, the retrieved at least one case to the at least one input;
generating, by the at least one processor based on a result of the adapting, at least one constraint that characterizes the at least one input, the at least one constraint relating to a rule that is mandated by the at least one input; and
evaluating, by the at least one processor, the at least one constraint.

2. The method of claim 1, wherein the input wording includes at least one from among a word, a phrase, a sentence, a paragraph, and a document in the natural language format, the document including electronic data in a document file format.

3. The method of claim 1, wherein parsing the at least one input to retrieve the at least one case further comprises:
determining, by the at least one processor using the at least one model, at least one annotation for the at least one input, the at least one annotation including a set of text abstractions and a corresponding word mapping;
determining, by the at least one processor using the at least one model, a similarity value between the at least one input and each of a plurality of cases in the case repository, the similarity value relating to a distance between a plurality of data points in a similarity grouping; and
identifying, by the at least one processor, the at least one case based on the similarity value and the predetermined similarity threshold.

4. The method of claim 3, wherein determining the at least one annotation further comprises:
accessing, by the at least one processor, at least one predefined list of concepts, the concepts including a set of values that are expected to appear in the at least one input and a text pattern matching expression that represents the set of values; and
determining, by the at least one processor using the at least one model, the at least one annotation for the at least one input based on the at least one predefined list of concepts.

5. The method of claim 1, wherein automatically adapting the retrieved at least one case to the at least one input further comprises:
computing, by the at least one processor using the at least one model, a merged mapping by,
updating, by the at least one processor, an input word mapping of the at least one input with a case word mapping of the retrieved at least one case; and
generating, by the at least one processor, a constraint based on the retrieved at least one case.

6. The method of claim 5, wherein generating the at least one constraint further comprises:
replacing, by the at least one processor, a set of text abstractions in the retrieved at least one case with information from the parsed at least one input by using the merged mapping; and
generating, by the at least one processor, the at least one constraint by using the constraint template and a result of the replacing.

7. The method of claim 1, wherein evaluating the at least one constraint further comprises:
presenting, by the at least one processor via the graphical user interface, a notification to at least one user associated with the at least one input, the notification including at least one from among the at least one constraint, a request for user feedback, and information that relates to retrieval of the at least one case; and
determining, by the at least one processor, whether the generated at least one constraint includes information that corresponds to the at least one input based on the user feedback,
wherein the user feedback is positive when the generated at least one constraint includes information that corresponds to the at least one input; and
wherein the user feedback is negative when the generated at least one constraint does not include information that corresponds to the at least one input.

8. The method of claim 7, further comprising:
requesting, by the at least one processor via the graphical user interface, at least one correct constraint from the at least one user when the user feedback is negative;
aggregating, by the at least one processor, data that corresponds to the at least one input, the data including the input wording and at least one related annotation;
computing, by the at least one processor, a new annotation for each of the at least one correct constraint;
generating, by the at least one processor, a new case by appending the new annotation to the aggregated data; and
indexing, by the at least one processor, the new case for storage in the case repository.

9. The method of claim 1, wherein the at least one model includes at least one from among a natural language processing model, a machine learning model, a mathematical model, a process model, and a data model.

10. A computing device configured to implement an execution of a method for translating natural language data into constraints via memory-based processing, the computing device comprising:
a processor;
a memory; and
a communication interface coupled to each of the processor and the memory,
wherein the processor is configured to:
receive, via a graphical user interface, at least one input, each of the at least one input including input wording in a natural language format;
parse, by using at least one model, the at least one input to retrieve at least one case from a case repository, the retrieval including identification of the at least one case based on a predetermined similarity threshold;
automatically adapt, by using the at least one model, the retrieved at least one case to the at least one input;
generate, based on a result of the adapting, at least one constraint that characterizes the at least one input, the at least one constraint relating to a rule that is mandated by the at least one input; and
evaluate the at least one constraint.

11. The computing device of claim 10, wherein the input wording includes at least one from among a word, a phrase, a sentence, a paragraph, and a document in the natural language format, the document including electronic data in a document file format.

12. The computing device of claim 10, wherein, to parse the at least one input to retrieve the at least one case, the processor is further configured to:
determine, by using the at least one model, at least one annotation for the at least one input, the at least one annotation including a set of text abstractions and a corresponding word mapping;
determine, by using the at least one model, a similarity value between the at least one input and each of a plurality of cases in the case repository, the similarity value relating to a distance between a plurality of data points in a similarity grouping; and
identify the at least one case based on the similarity value and the predetermined similarity threshold.

13. The computing device of claim 12, wherein, to determine the at least one annotation, the processor is further configured to:
access at least one predefined list of concepts, the concepts including a set of values that are expected to appear in the at least one input and a text pattern matching expression that represents the set of values; and
determine, by using the at least one model, the at least one annotation for the at least one input based on the at least one predefined list of concepts.

14. The computing device of claim 10, wherein, to automatically adapt the retrieved at least one case to the at least one input, the processor is further configured to:
compute, by using the at least one model, a merged mapping by causing the processor to,
update an input word mapping of the at least one input with a case word mapping of the retrieved at least one case; and
generate a constraint based on the retrieved at least one case.

15. The computing device of claim 14, wherein, to generate the at least one constraint, the processor is further configured to:
replace a set of text abstractions in the retrieved at least one case with information from the parsed at least one input by using the merged mapping; and
generate the at least one constraint by using the constraint template and a result of the replacing.

16. The computing device of claim 10, wherein, to evaluate the at least one constraint, the processor is further configured to:
present, via the graphical user interface, a notification to at least one user associated with the at least one input, the notification including at least one from among the at least one constraint, a request for user feedback, and information that relates to retrieval of the at least one case; and
determine whether the generated at least one constraint includes information that corresponds to the at least one input based on the user feedback,
wherein the user feedback is positive when the generated at least one constraint includes information that corresponds to the at least one input; and
wherein the user feedback is negative when the generated at least one constraint does not include information that corresponds to the at least one input.

17. The computing device of claim 16, wherein the processor is further configured to:
request, via the graphical user interface, at least one correct constraint from the at least one user when the user feedback is negative;
aggregate data that corresponds to the at least one input, the data including the input wording and at least one related annotation;
compute a new annotation for each of the at least one correct constraint;
generate a new case by appending the new annotation to the aggregated data; and
index the new case for storage in the case repository.

18. The computing device of claim 10, wherein the at least one model includes at least one from among a natural language processing model, a machine learning model, a mathematical model, a process model, and a data model.

19. A non-transitory computer readable storage medium storing instructions for translating natural language data into constraints via memory-based processing, the storage medium comprising executable code which, when executed by a processor, causes the processor to:
receive, via a graphical user interface, at least one input, each of the at least one input including input wording in a natural language format;
parse, by using at least one model, the at least one input to retrieve at least one case from a case repository, the retrieval including identification of the at least one case based on a predetermined similarity threshold;
automatically adapt, by using the at least one model, the retrieved at least one case to the at least one input;
generate, based on a result of the adapting, at least one constraint that characterizes the at least one input, the at least one constraint relating to a rule that is mandated by the at least one input; and
evaluate the at least one constraint.

20. The storage medium of claim 19, wherein the input wording includes at least one from among a word, a phrase, a sentence, a paragraph, and a document in the natural language format, the document including electronic data in a document file format.
